(19) United States
(12) Patent Application Publication
(10) Pub. No.: US 2024/0119631 A1
(43) Pub. Date: Apr. 11, 2024

(54) TIRE OBSERVATION APPARATUS

(71) Applicant: Murata Manufacturing Co., Ltd., Nagaokakyo-shi (JP)

(72) Inventor: Seiji INNAMI, Nagaokakyo-shi (JP)

(21) Appl. No.: 18/542,828

(22) Filed: Dec. 18, 2023

Related U.S. Application Data
(63) Continuation of application No. PCT/JP2022/026780, filed on Jul. 6, 2022.

(30) Foreign Application Priority Data
Jul. 7, 2021 (JP) 2021-112685

(51) Int. Cl. G06T 7/80; G06T 7/00

(52) U.S. Cl. CPC G06T 7/80; G06T 7/0004

(57) ABSTRACT

A tire observation apparatus includes a computer and an imaging device including a camera and range sensors positioned at different angles relative to a ground surface. The computer is configured or programmed to calculate a position of a tire relative to the camera by using various distances to the tire calculated by the range sensors. By using the position of the tire, the computer is configured or programmed to calculate an amount of adjustment usable by the imaging device to adjust the position and an angle of the camera such that an imaging center of the camera is directed at a center of the tire or at a surface of the tire that is to be measured.

### CROSS REFERENCE TO RELATED APPLICATIONS

This application claims the benefit of priority to Japanese Patent Application No. 2021-112685 filed on Jul. 7, 2021 and is a Continuation application of PCT Application No. PCT/JP2022/026780 filed on Jul. 6, 2022. The entire contents of each application are hereby incorporated herein by reference.

### BACKGROUND OF THE INVENTION

### 1. Field of the Invention

The present invention relates to techniques for observing the condition of a tire of a vehicle.

### 2. Description of the Related Art

Japanese Unexamined Patent Application Publication No. 2017-500540 describes an apparatus that analyzes the condition of a tire by using a camera, an illumination light source, and a data processing unit. The apparatus described in Japanese Unexamined Patent Application Publication No. 2017-500540 sequentially images, with the camera, a surface of the tire that is irradiated with light from the illumination light source. The apparatus thus acquires multiple images of the tire surface. From the sequentially acquired images, the data processing unit generates an image of the tread of the tire, and inspects the condition of the tire.

Japanese Unexamined Patent Application Publication No. 2017-198672 describes an apparatus that inspects the condition of the surface of a tire such as wear or damage by using the following components: two cameras arranged in the width direction of the tire; an illuminator, and a processing unit. The apparatus described in Japanese Unexamined Patent Application Publication No. 2017-198672 images, with the two cameras, the surface of the tire irradiated with light from the illumination light source. The processing unit performs the inspection by using a composite image produced from the two cameras.

Known methods for measuring the condition of the tire surface include the light-section method, and the method of creating a developed view. With these methods, the accuracy of measurement depends significantly on the positional relationship between the tire surface to be measured, and a device such as the camera or the illuminator.

With the techniques described in Japanese Unexamined Patent Application Publication No. 2017-500540 and Japanese Unexamined Patent Application Publication No. 2017-198672, however, it is difficult to locate a device such as the camera or the illuminator at a position suitable for accurate measurement relative to the tire to be measured. For a vehicle in motion, in particular, it is difficult to dispose such a device at a position suitable for accurate measurement.

### SUMMARY OF THE INVENTION

Example embodiments of the present invention provide techniques to locate a camera, an illuminator, or other such device at a position suitable for accurate measurement relative to a tire of a vehicle that is in motion.

A tire observation apparatus according to an example embodiment of the present invention includes a camera, a plurality of range sensors, a first position and angle controller, and a computer. The camera is provided at a ground where a vehicle including a tire to be measured passes. The camera is operable to acquire an image of the tire while the vehicle is in motion. Examples of the ground in this case include a road, a parking lot, or other places where a vehicle passes, and the floor of an indoor space where vehicle maintenance is performed. Each of the plurality of range sensors is provided at a fixed position relative to the camera, and is operable to measure a distance to the tire. The first position and angle controller is configured or programmed to adjust the positions of the camera and of each of the plurality of range sensors at the ground, and/or an angle of the camera and of each of the plurality of range sensors. The computer is configured or programmed to measure the surface condition of the tire by using the image of the tire acquired with the camera.

The plurality of range sensors are positioned at different angles relative to the surface of the ground. The computer is configured or programmed to calculate the position of the tire relative to the camera by using multiple distances to the tire calculated by the plurality of range sensors. The computer is configured or programmed to calculate a first amount of adjustment using the position of the tire. The first amount of adjustment is an amount by which to adjust the position and the angle of the camera such that the center or approximate center of the camera is directed at the imaging center of the tire or at a surface of the tire that is to be measured. The first position and angle controller is configured or programmed to adjust the position and the angle of the camera by using the first amount of adjustment.

According to the configuration described above, the distances between the camera and multiple circumferential positions on the tire are measured by the plurality of range sensors. Measuring multiple circumferential positions on the tire in this way enables the camera to be adjusted in position and angle relative to the center of the tire and to a predetermined position on the tire surface. Therefore, the camera is adjusted to a position and an angle that are suitable to measure of the condition of the tire.

Example embodiments of the present invention each enables the camera, the illuminator, or other such device to be disposed at a position suitable for accurate measurement relative to a tire of a vehicle that is in motion.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 illustrates an example of how a tire observation apparatus according to an example embodiment of the present invention is positioned.

FIG. 2 is a block diagram illustrating a configuration of a tire observation apparatus according to an example embodiment of the present invention.

FIG. 3 is a functional block diagram of a portion of a computer according to an example embodiment of the present invention.

FIG. 4 is a diagram of a tire observation system including a tire observation apparatus, schematically illustrating a portion of the tire observation system according to an example embodiment of the present invention.

FIG. 5 is an external perspective view of an imaging device according to an example embodiment of the present invention.

FIG. 6A is a side view of an imaging device according to an example embodiment of the present invention, FIG. 6B is a plan view of the imaging device, and FIG. 6C is an enlarged front view of a camera portion of the imaging device.

FIG. 7 is a flowchart illustrating main processing to be executed by a tire observation apparatus 20 according to an example embodiment of the present invention.

FIG. 8 is a flowchart illustrating an example of a vehicle-information acquisition process indicated at S100.

FIG. 9 is a flowchart illustrating a measurement-start determination process.

FIG. 10 is a flowchart illustrating a specific example of activation of an illuminator according to an example embodiment of the present invention.

FIGS. 11A and 11B each schematically illustrate a first example of an angular relationship between a tire surface and an imaging device at the time of initial adjustment.

FIG. 12 is a flowchart illustrating a first aspect of initial angle adjustment.

FIGS. 13A to 13C each schematically illustrate a second example of an angular relationship between a tire surface and an imaging device at the time of initial adjustment.

FIGS. 14A to 14C each schematically illustrate a third example of an angular relationship between a tire surface and an imaging device at the time of initial adjustment.

FIGS. 15A and 15B each schematically illustrate an example of an angular relationship between a tire surface and an imaging device at the time of initial adjustment.

FIG. 16 is a flowchart illustrating a non-limiting example of an angle adjustment method using range sensors according to an example embodiment of the present invention.

FIG. 17 is a flowchart illustrating a non-limiting example of an angle adjustment method using a range sensor according to an example embodiment of the present invention.

FIG. 18 illustrates an example of angle and distance measurements of a range sensor relative to a tire, and an example of a tire shape model based on the measurements.

FIG. 19 is a flowchart of a first aspect of initial adjustment of a position of an imaging device, illustrating an example of initial adjustment made by using an image of line-shaped radiant light radiated by the illuminator.

FIGS. 20A to 20D each schematically illustrate an example of a positional relationship between a tire and an imaging device at the time of initial adjustment.

FIGS. 21A to 21C each schematically illustrate an example of a positional relationship between a tire and an imaging device at the time of initial adjustment.

FIG. 22 is a flowchart illustrating a second position adjustment method according to an example embodiment of the present invention.

FIG. 23 is a flowchart illustrating a measurement process for a surface condition of a tire.

FIG. 24 illustrates, in side view, an initial measurement angle of a camera.

FIG. 25A illustrates, in side view, the process to determine center coordinates of a tire, and FIG. 25B illustrates, in side view, a vertical angle ΨC of a camera when an optical axis of the camera is directed at the center of the tire according to an example embodiment of the present invention.

FIG. 26 is a flowchart illustrating a measurement process using image processing to measure a surface condition of a tire.

FIGS. 27A and 27C each illustrate an example of a positional relationship between the tire and the camera when image processing is performed, and FIGS. 27B and 27D each illustrate an example of a resulting image.

FIGS. 28A and 28B illustrate an imaging process performed with different distances between a tire and a measurement apparatus, the imaging process including radiating, with the illuminator 213, line-shaped radiant light toward a center of the tire, and imaging, at a center of a camera, the line-shaped radiant light radiated onto the tire, and FIGS. 28C and 28D each illustrate an example of the resulting image.

### DETAILED DESCRIPTION OF THE EXAMPLE EMBODIMENTS

Tire observation techniques according to example embodiments of the present invention are described below with reference to the drawings.

### Configuration of Tire Observation Apparatus

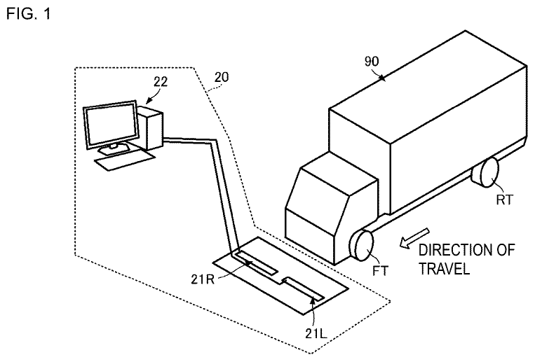

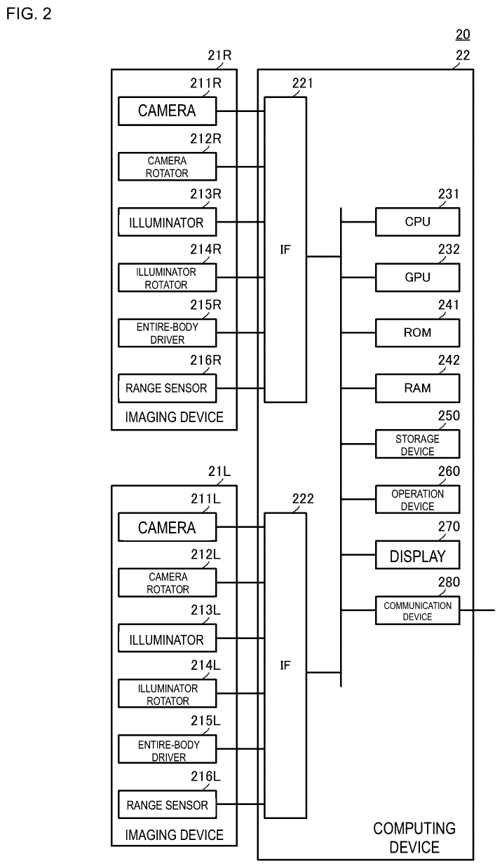

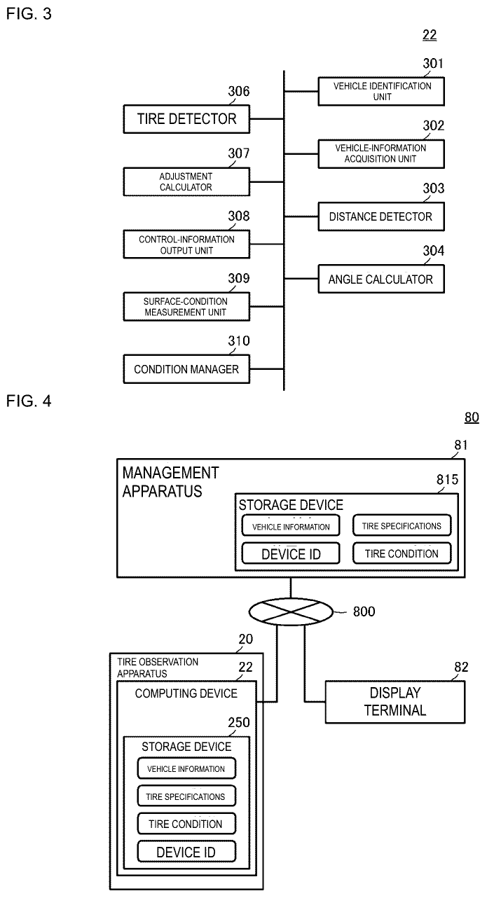

FIG. 1 illustrates an example of how a tire observation apparatus according to an example embodiment of the present invention is positioned. FIG. 2 is a block diagram illustrating the configuration of the tire observation apparatus according to the present example embodiment of the present invention. FIG. 3 is a functional block diagram of a portion of a computer according to the present example embodiment of the present invention.

As illustrated in FIGS. 1 and 2, a tire observation apparatus 20 includes an imaging device 21R, an imaging device 21L, and a computer 22.

The imaging device 21R and the imaging device 21L are the same or similar in configuration to each other. The structure of the imaging devices 21R and 21L will be described in more detail later as the structure of an imaging device 21. The imaging device 21R and the imaging device 21L include the same or similar structural features. Accordingly, unless required otherwise, the imaging device 21R and the imaging device 21L are hereinafter referred to collectively, without distinction, as imaging device 21.

The imaging device 21 (21R, 21L) is disposed near the surface of the ground on which a vehicle 90 travels. The imaging device 21 is disposed at the ground such that the imaging device 21 does not break as the vehicle 90 moves over the imaging device 21. For example, the imaging device 21 is covered with a cover that prevents the imaging device 21 from breaking as the vehicle 90 moves over the imaging device 21. The imaging device 21R is disposed at the ground such that, at this time, tires FT and RT of the vehicle 90 enter a predetermined image acquisition range for a camera 211 (211R, 211L), and a predetermined measurable range for a range sensor 216 (216R, 216L).

The imaging device 21R and the imaging device 21L are arranged alongside each other in a direction orthogonal or substantially orthogonal to the direction of travel of the vehicle 90. In actuality, the vehicle approaches the imaging devices 21R and 21L arranged alongside each other in parallel or substantially in parallel such that measurement begins simultaneously for both imaging devices. The imaging device 21R is disposed at a position that enables imaging of the tires FT and RT on the right side of the vehicle 90. The imaging device 21L is disposed at a position that enables imaging of the tires FT and RT on the left side of the vehicle 90. The spacing between the imaging device 21R and the imaging device 21L is set to be equal or substantially equal to the spacing between the tires FT on opposite lateral sides of the vehicle 90. If there are multiple types of vehicles 90, the spacing between the imaging device 21R and the imaging device 21L can be adjusted. In one example, a slider movement device described later can be used for such adjustment.

The computer 22 is installed at a position different from the imaging device 21. The computer 22 is electrically connected to the imaging device 21 by a cable or other connection. The imaging device 21 may communicate wirelessly with the computer 22 by a wireless communication device disposed near the imaging device 21.

### Functional Configuration of Tire Observation Apparatus 20

As illustrated in FIG. 2, the imaging device 21 (21R, 21L) includes the camera 211 (211R, 211L), a camera rotator 212 (212R, 212L), an illuminator 213 (213R, 213L), an illuminator rotator 214 (214R, 214L), an entire-body driver 215 (215R, 215L), and the range sensor 216 (216R, 216L). These components of the imaging device 21 are connected to an interface (IF) 221 of the computer 22. A portion of the imaging device 21 that adjusts the position and angle of the camera 211 corresponds to “first position and angle controller”. A portion of the imaging device 21 that adjusts the position and angle of the illuminator 213 corresponds to “second position and angle controller”. The entire-body driver 215 corresponds to each of “third angle controller” and “third position controller”.

The camera 211 acquires an image of a preset imaging range (e.g., an imaging range including the tire FT or the tire RT of the vehicle 90). The camera 211 outputs the acquired image to the computer 22.

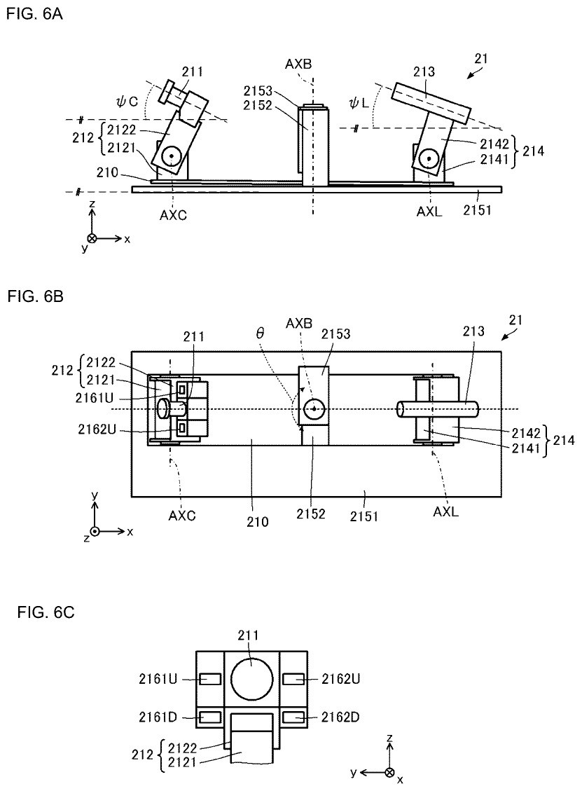

The camera rotator 212 rotates the camera 211 so as to change an angle between the optical axis of the camera 211 and the ground (an angle ΨC in FIG. 6A (which is shown in FIG. 6 as an angle with a horizontal plane parallel or substantially parallel to the ground)), and fixes the camera 211 at a predetermined angle. In other words, the camera rotator 212 rotates the camera 211 about a rotation axis (a rotation axis AXC illustrated in FIGS. 6A and 6B) parallel or substantially parallel to the ground and perpendicular or substantially perpendicular to the optical axis of the camera 211. The camera rotator 212 executes rotation control based on camera-rotation control information provided from the computer 22.

The illuminator 213 radiates light with a predetermined shape (e.g., line-shaped radiant light). The illuminator 213 executes control of illumination (such as the shape of illumination or ON/OFF of illumination) based on illumination control information provided from the computer 22.

The illuminator rotator 214 rotates the illuminator 213 so as to change an angle between the optical axis of the illuminator 213 and the ground (an angle ΨL in FIG. 6A) (which is shown in FIGS. 6A to 6C as an angle with a horizontal plane parallel or substantially parallel to the ground)), and fixes the illuminator 213 at a predetermined angle. In other words, the illuminator rotator 214 rotates the illuminator 213 about a rotation axis (a rotation axis AXL illustrated in FIGS. 6A and 6B)) parallel or substantially parallel to the ground and perpendicular or substantially perpendicular to the optical axis of the illuminator 213. The illuminator rotator 214 executes rotation control based on illuminator-rotation control information provided from the computer 22.

The range sensor 216 is disposed at a fixed position relative to the camera 211. The range sensor 216 measures the distance to a target object (tire FT or the tire RT) using a predetermined method (e.g., by using a laser beam or an ultrasonic wave). The range sensor 216 outputs the measured distance to the computer 22.

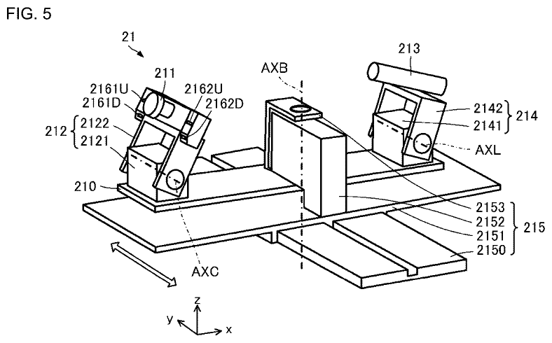

The entire-body driver 215 is capable of moving a mount 210 (see FIG. 5, FIGS. 6A and 6B)) in the horizontal direction, or rotating the mount 210 in a horizontal plane. The camera 211, the illuminator 213, and the range sensor 216 are mounted to the mount 210. Control of driving of the entire-body driver 215R is executed based on entire-body movement/rotation control information provided from the computer 22.

The above-described controls for the imaging device 21R, and the above-described controls for the imaging device 21L are performed individually by the computer 22.

The computer 22 is, for example, a personal computer. The computer 22 includes, for example, the IF 221, an IF 222, a CPU 231, a GPU 232, a ROM 241, a RAM 242, a storage 250, an operation device 260, a display 270, and a communication device 280. The storage 250 is, for example, a magnetic medium. The display 270 is, for example, a liquid crystal display. The communication device 280 connects the computer 22 to an external information communication network 800 (see FIG. 4). The computer 22 does not necessarily have to include devices such as the operation device or the display. Instead of such devices, an external apparatus connected by the communication device may be used.

As illustrated in FIG. 3, the following functional components of the computer 22 are provided by the CPU 231, the GPU 232, the ROM 241, and the RAM 242, a vehicle identification circuit 301, a vehicle-information acquisition circuit 302, a distance detector 303, an angle calculator 304, a trajectory estimator 305, a tire detector 306, an adjustment calculator 307, a control-information output circuit 308, a surface-condition measurement circuit 309, and a condition manager 310. That is, in the computer 22, a program to use the functional units illustrated in FIG. 3 is stored in the ROM 241, and the program is executed by the CPU 231 and the GPU 232. At this time, the RAM 242 is used as a working area.

Specific processing to be executed by the above-described circuits will be described later where appropriate. The functions of the above-described circuits are now described below.

The vehicle identification circuit 301 identifies a vehicle from an image acquired by at least one of the camera 211R or the camera 211L.

The vehicle-information acquisition circuit 302 acquires vehicle information (such as a license plate or a vehicle ID) on the vehicle 90 from an image acquired by at least one of the camera 211R or the camera 211L. The vehicle-information acquisition circuit 302 acquires, from the vehicle information, tire specifications (such as, for example, tire diameter, tire width, the spacing between tires on opposite lateral sides, and the spacing between the front tire FT and the rear tire RT) of the vehicle 90. The vehicle information can be acquired not only from an image acquired by the camera 211, but also by use of ETC, RFID, or other systems.

FIG. 4 is a diagram of a tire observation system including the tire observation apparatus, schematically illustrating a portion of the tire observation system related to characteristic features of the present invention. A tire observation system 80 includes the tire observation apparatus 20, a management apparatus 81, a display terminal 82, and the information communication network 800. The computer 22 of the tire observation apparatus 20, the management apparatus 81, and the display terminal 82 are interconnected by the information communication network 800. The storage 250 of the computer 22, and a storage 815 of the management apparatus 81 each store information such as vehicle information, tire specifications, tire condition, and device ID. Vehicle information, tire specifications, and tire condition are associated with each other.

The vehicle-information acquisition circuit 302 acquires tire specifications from the storage 250, if vehicle information has already been registered in the storage 250 and the corresponding tire specifications have been stored. If no vehicle information has been registered in the storage 250, the vehicle-information acquisition circuit 302 introduces vehicle information to the management apparatus 81. The management apparatus 81 reads tire specifications from the storage 815 based on vehicle information, and transmits the tire specifications to the computer 22. The vehicle-information acquisition circuit 302 is thus able to acquire the tire specifications. Alternatively, all such management may be centralized on the management apparatus 81. In this case, no vehicle information may be stored in the storage 250 of the tire observation apparatus 20, and vehicle information may be acquired, after vehicle identification, from the management apparatus 81 (e.g., server) that manages vehicle information.

The distance detector 303 detects the distance between the camera 211, and the tire FT or the tire RT of the vehicle 90 from an image acquired by the camera 211.

The angle calculator 304 calculates, by using an image acquired by the camera 211 or a distance measured by the range sensor, an angle between the camera 211, and the tire FT or the tire RT of the vehicle 90 in a horizontal plane (horizontal angle) or in the vertical direction (vertical angle).

The tire detector 306 detects, from an image acquired by the camera 211, the tire FT or the tire RT of the vehicle 90.

The adjustment calculator 307 calculates amounts of adjustment by using the distance detected by the distance detector 303 and the angle measured by the angle calculator 304. Such amounts of adjustment include an amount by which to adjust the vertical angle of the camera 211 or the illuminator 213 described above, an amount by which to adjust the amount of movement in the horizontal direction for the entire-body driver 215; and an amount by which to adjust the horizontal angle for the entire-body driver 215.

The control-information output circuit 308 generates, by use of the amounts of adjustment calculated by the adjustment calculator 307, the following information as appropriate: the camera-rotation control information, the illuminator-rotation control information, and the movement/rotation control information. The control-information output circuit 308 outputs the camera-rotation control information to the camera rotator 212, outputs the illuminator-rotation control information to the illuminator rotator 214, and outputs the movement/rotation control information to the entire-body driver 215.

The surface-condition measurement circuit 309 measures, from an image acquired by the camera 211, the surface condition (e.g., groove depth or uneven wear) of each of the tire FT and the tire RT.

The condition manager 310 associates measurement results and vehicle information with each other, and stores the resulting information into the storage device 250. The condition manager 310 associates measurement results and vehicle information with each other, and transmits the resulting information to the management apparatus 81 via the information communication network 800. Based on the received vehicle information, the management apparatus 81 stores the measurement results into the storage device 815.

### Structure of Imaging Device 21

FIG. 5 is an external perspective view of the imaging device according to the present example embodiment. FIG. 6A is a side view of the imaging device according to the present example embodiment. FIG. 6B is a plan view of the imaging device. FIG. 6C is an enlarged front view of a camera portion of the imaging device.

The imaging device 21 includes the mount 210, the camera 211, the camera rotator 212, the illuminator 213, the illuminator rotator 214, the entire-body driver 215, and multiple range sensors 2161U, 2161D, 2162U, and 2162D. The range sensors 2161U and 2162U each correspond to “first range sensor”, and the range sensors 2161D and 2162D each correspond to a “second range sensor”. One of the range sensor 2161U and the range sensor 2162U corresponds to a “third range sensor”, and the other range sensor corresponds to a “fourth range sensor”.

The mount 210 is a flat plate with a plane that extends in the x-axis direction and the y-axis direction. The x-axis direction and the y-axis direction are parallel or substantially parallel to the ground.

The camera rotator 212 includes a base 2121, and a camera securing support 2122. The base 2121 is secured in position near one end of the mount 210 in the x-axis direction. A motor with the rotation axis AXC parallel or substantially parallel to the y-axis direction is built in the base 2121. The camera securing support 2122 is mounted to the base 2121 in a manner that allows the camera securing support 2122 to be rotated by the motor described above.

The camera 211 is secured to the camera securing support 2122. The camera 211 is positioned such that, in the x-direction of the imaging device 21, the camera 211 images an area located outward of a first end portion of the mount 210, which is an end portion where the camera 211 and the camera rotator 212 are mounted. As the camera securing support 2122 rotates with rotation of the motor, the optical axis of the camera 211 (the center of the imaging range) rotates about the rotation axis AXC. The camera 211 thus rotates with the horizontal direction as the rotation axis. This allows the optical axis of the camera 211 to be scanned in the vertical direction. The camera 211 can be fixed at a predetermined vertical angle ΨC.

The illuminator rotator 214 includes a base 2141, and an illuminator securing support 2142. The base 2121 is secured to a second end portion of the mount 210 in the x-axis direction. That is, the illuminator 213 is located rearward with respect to the imaging direction of the camera 211. A motor with the rotation axis AXL parallel or substantially parallel to the y-axis direction is built in the base 2141. The illuminator securing support 2142 is mounted to the base 2141 in a manner that allows the illuminator securing support 2142 to be rotated by the motor described above.

The illuminator 213 is secured to the illuminator securing support 2142. With respect to the x-direction of the imaging device 21, the illuminator 213 is positioned to provide radiation in the same or substantially the same direction as the imaging direction of the camera 211. As the illuminator securing support 2142 rotates with rotation of the motor, the optical axis of the illuminator 213 rotates about the rotation axis AXL. The illuminator 213 thus rotates with the horizontal direction as the rotation axis. This allows the optical axis of the illuminator 213 to be scanned in the vertical direction. The illuminator 213 can be fixed at a predetermined vertical angle ΨL.

The rotation axis AXC and the rotation axis AXL are parallel or substantially parallel to each other. Preferably, to increase the accuracy of a measurement technique described later, the rotation axis AXC and the rotation axis AXL are arranged alongside each other in the x-axis direction. In an alternative configuration, the camera 211 and the illuminator 213 may be positioned such that the illuminator 213 is located near the first end portion, and the camera 211 is located near the second end portion.

The range sensors 2161U, 2162U, 2161D, and 2162D are secured to the camera securing support 2122. The range sensors 2161U, 2162U, 2161D, and 2162D are thus fixed in position relative to the camera 211.

The range sensor 2161U and the range sensor 2162U are positioned to sandwich the camera 211 in the horizontal direction. As a result, the optical axis of the camera 211, and the measurement center of each of the range sensor 2161U and the range sensor 2162U are located at the same or substantially the same position in the vertical direction. Further, in the horizontal direction, the optical axis of the camera 211 is preferably located at the middle position between the center of the range sensor 2161U as seen in front view, and the center of the range sensor 2162U as seen in front view.

The range sensor 2161U and the range sensor 2162U perform ranging by transmitting a detection wave (e.g., a laser beam or an ultrasonic wave) in a direction parallel or substantially parallel to the optical axis of the camera 211, and receiving the reflection of the transmitted wave. That is, the imaging direction of the camera 211, and the ranging direction of each of the range sensor 2161U and the range sensor 2162U are the same or substantially the same.

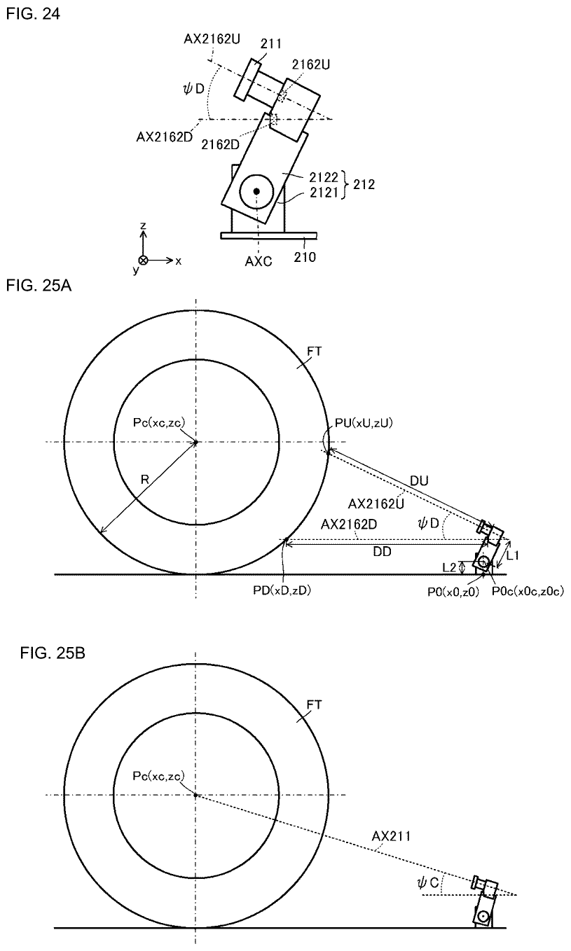

The range sensor 2161D is disposed below the range sensor 2161U in the vertical direction. The range sensor 2161D is positioned relative to the range sensor 2161U such that, with the direction parallel or substantially parallel to the rotation axis AXC or the rotation axis AXL defined as the rotation axis, the respective center axes of the range sensors 2161D and 2161U define an angle ΨD (see, for example, FIG. 24).

Preferably, the above-described angle ΨD may be, for example, greater than or equal to about 10 degrees and less than or equal to about 70 degrees. More preferably, the angle ΨD may be, for example, about 30 degrees. This is effective in, for example, calculation of the center position of the tire FT or RT that will be described later. For example, if the angle is too large, it is difficult to capture two points in the circumferential direction of the tire FT or RT, whereas if the angle is too small, a small measurement error is likely to lead to a large error in the calculated position of the center of the tire FT or RT. Setting the range sensor 216 at an appropriate angle allows calculation of the center position of the tire FT or RT to be performed with improved reliability, and allows the center position of the tire FT or RT to be calculated with improved accuracy.

The range sensor 2161D and the range sensor 2162D each perform ranging by transmitting a detection wave (e.g., a laser beam or an ultrasonic wave) in a direction parallel or substantially parallel to its center axis, and receiving the reflection of the transmitted wave. The range sensor 2161D and the range sensor 2162D thus perform ranging in such a way that their respective ranging directions form the angle ΨD with the ranging directions of the range sensor 2161U and the range sensor 2162U.

The entire-body driver 215 includes a slider 2150, a slider mating structure 2151, a support 2152, and a mount securing structure 2153. The entire-body driver 215 corresponds to a “third position control device” or a “third angle controller”.

The slider 2150 extends in the y-direction. The slider 2150 includes a groove parallel or substantially parallel to the y-direction. The slider mating structure 2151 is disposed in such a way that the slider mating structure 2151 mates with the groove of the slider 2150 to allow movement along the groove. The slider mating structure 2151 is provided with a power source (not illustrated). Power from the power source allows the slider mating structure 2151 to move along the groove of the slider 2150. The slider mating structure 2151 can be fixed at a predetermined position along the groove.

The support 2152 is secured to the slider mating structure 2151. A motor with a rotation axis AXB parallel to the z-axis direction is built in the support 2152.

The mount securing structure 2153 is mounted to the support 2152 in a manner that allows the mount securing structure 2153 to be rotated by the motor described above. The mount securing structure 2153 is secured to the mount 210 at the middle position of the mount 210 between the position where the camera 211 is located and the position where the illuminator 213 is located.

As the mount securing structure 2153 rotates with rotation of the motor of the support 2152, the mount 210 rotates about the rotation axis AXB. This allows the camera 211, the illuminator 213, and the range sensors 2161U, 2162U, 2161D, and 2162D to rotate in a horizontal plane.

The imaging device 21 configured as described above is installed at the ground such that the direction of travel of the vehicle 90 is parallel or substantially parallel to the x-axis direction, and that a direction orthogonal or substantially orthogonal to the direction of travel is parallel or substantially parallel to the y-axis direction.

As a result of the configuration described above, the imaging device 21 allows the vertical angle ΨC, that is, the imaging direction of the camera 211 to be set to a desired angle by means of the camera rotator 212. The imaging device 21 allows the vertical angle ΨL, that is, the direction of radiation of the illuminator 213 to be set to a desired angle. The imaging device 21 allows the ranging direction of each of the range sensors 2161U, 2162U, 2161D, and 2162D to be set to a desired angle by the illuminator rotator 214.

The imaging device 21 allows each of the camera 211, the illuminator 213, and the range sensors 2161U, 2162U, 2161D, and 2162D to be set, by the entire-body driver 215, to a desired position in a direction that is orthogonal substantially orthogonal to the direction of travel of the vehicle 90 in a horizontal plane. The imaging device 21 allows the camera 211, the illuminator 213, and the range sensors 2161U, 2162U, 2161D, and 2162D to be set, by the entire-body driver 215, to a desired angle in the horizontal plane.

### Tire Observation Method

The tire observation apparatus 20 is configured as described above to measure the surface condition of the tire in a manner described below.

### Main Processing

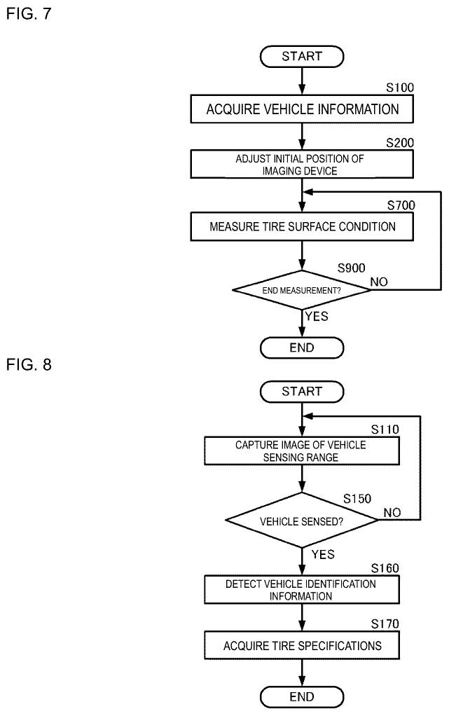

FIG. 7 is a flowchart illustrating main processing to be executed by the tire observation apparatus 20. As illustrated in FIG. 7, the tire observation apparatus 20 acquires vehicle information on the vehicle 90 that is moving toward the tire observation apparatus 20 (S100). The tire observation apparatus 20 acquires tire specifications from the vehicle information.

The tire observation apparatus 20 performs initial adjustment of the position of the imaging device 21 (S200). In brief, the tire observation apparatus 20 controls the imaging device 21 such that the camera 211 is positioned substantially directly in front of the tire FT of the vehicle 90.

At this time, the tire observation apparatus 20 adjusts the position of a component such as the camera 211 in the tire width direction through control of the entire-body driver 215 by using at least one of the following pieces of information: an image of line-shaped radiant light radiated by the illuminator 213, and distance measurements obtained with multiple range sensors. The position in the tire width direction in this case means the position in a direction orthogonal or substantially orthogonal to the direction of travel of the vehicle in the horizontal plane, that is, the position in a direction parallel or substantially parallel to the vehicle width direction of the vehicle that is in motion.

The tire observation apparatus 20 measures the surface condition of the tire FT (S700). First, prior to measurement, the tire observation apparatus 20 performs fine adjustment of the position and angle of the imaging device 21 through control of the camera rotator 212, the illuminator rotator 214, or other components. In brief, the tire observation apparatus 20 controls the imaging device 21 such that the camera 211 is located substantially at the center in the tire width direction, and that the optical axis of the camera 211 is directed at strikes an appropriate measurement point on the tire FT. At this time, the tire observation apparatus 20 adjusts the position in the tire width direction, and the angle in the horizontal direction, of a component such as the camera 211, by using at least of the following pieces of information: an image of line-shaped radiant light radiated by the illuminator 213, and distance measurements obtained with multiple range sensors. The angle in the horizontal direction in this case refers to an angle in a horizontal plane, with the vertical direction orthogonal or substantially orthogonal to the ground defined as the rotation axis.

After the fine adjustment is finished, the surface condition of the tire FT is measured. In brief, while keeping the optical axis of the camera 211 directed at the appropriate measurement point on the tire FT, the tire observation apparatus 20 measures, by using an image obtained with the camera 211, the surface condition (e.g., groove depth or uneven wear) of the tire FT by, for example, image analysis or the light-section method.

If a condition to end the measurement is not met (S900: NO), the tire observation apparatus 20 continuously performs the fine adjustment and the measurement. If the condition to end the measurement is met (S900: YES), the tire observation apparatus 20 ends the measurement.

The procedure described above represents an example of how measurement is performed for the front tire FT. Accordingly, to measure the surface condition of the rear tire RT, for example, the steps S100 to S700 described above may be simply performed for the rear tire RT after measurement is performed for the front tire FT. If another intermediate tire exists between the front tire FT and the rear tire RT, processing the same as or similar to that performed for the rear tire RT may be simply performed for the intermediate tire as well.

### Vehicle-Information Acquisition Process

FIG. 8 is a flowchart illustrating a non-limiting example of the vehicle-information acquisition process indicated at S100. The processing to be executed by the computer 22 in the following description is executed by a suitable combination of the various functional units described above with reference to FIG. 3.

The camera 211 captures an image of a vehicle sensing range (S110). The computer 22 analyzes the image to sense the presence or absence of the vehicle 90. If the computer 22 senses no vehicle 90 (S22: NO), the camera 211 continues to capture an image of the vehicle sensing range. The imaging interval in this case can be set as appropriate.

In response to sensing the vehicle 90 (S150: YES), the computer 22 detects vehicle identification information (such as a license plate, a vehicle model, or a two-dimensional barcode) from the image (S160).

The computer 22 references the vehicle identification information, and acquires tire specifications (S170). At this time, if vehicle identification information is already stored in the storage device 250, the computer 22 acquires the tire specifications from the storage device 250. If no vehicle identification information is stored in the storage device 250, the computer 22 acquires the tire specifications from the management apparatus 81.

At this time, the computer 22 may, as required, acquire vehicle shape information together with the tire specifications.

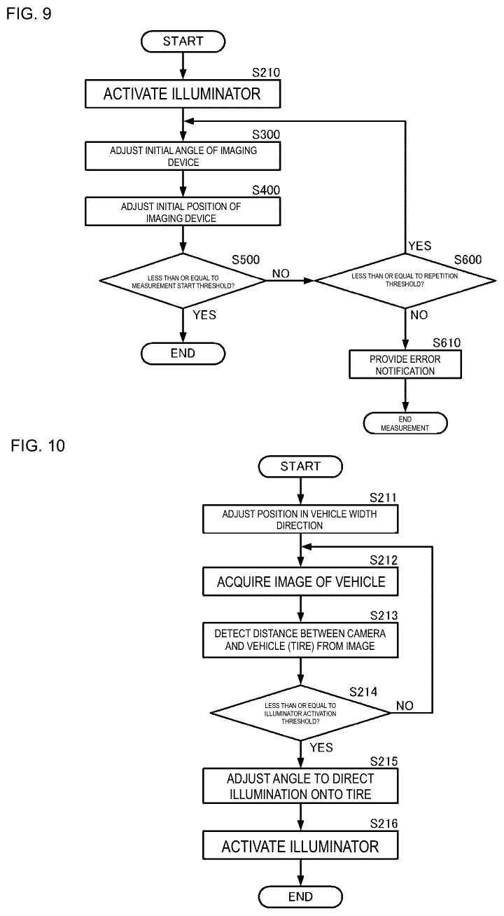

After the process of acquiring vehicle information is finished, the flowchart then moves on to the process of initial adjustment of the observation apparatus (S200). FIG. 9 represents a subdivision of the process at S200 into individual functions. FIG. 9 is a flowchart illustrating main processing to be executed for initial adjustment of distance and angle.

First, the computer 22 activates the illuminator (S210). After performing initial angle adjustment of the imaging device (S300), the computer 22 performs initial position adjustment of the imaging device (S400). Multiple methods exist to perform the initial position adjustment and the initial angle adjustment mentioned above. Accordingly, the adjustments can be made using such methods in a suitable combination adapted to the associated vehicle model or location.

After the initial position adjustment is finished, the computer 22 then detects the distance between the tire and the imaging device. If the distance is less than or equal to a measurement-start threshold (S500: YES), the computer 22 ends the initial adjustment process, and proceeds to a process of performing fine measurement for measurement (S700). If the distance is greater than the measurement-start threshold (S500: NO), the computer 22 proceeds to check the number of times initial adjustment such as the initial position adjustment or initial angle adjustment has been repeated (S600). If the number of times is less than a repetition threshold (S600: Yes), the computer 22 repeats the adjustment again from the initial angle adjustment. If the number of times initial adjustment such as the initial position adjustment or initial angle adjustment has been repeated is greater than the repetition threshold (S600: No), the computer 22 determines that the vehicle may be at rest or moving backward. The computer 22 thus provides an error notification (S610), and ends the measurement. Hereinafter, where appropriate, a position adjustment performed during initial adjustment (initial position adjustment) is referred to simply as “position adjustment”, and an angle adjustment performed during initial adjustment (initial angle adjustment) is referred to simply as “angle adjustment.”

### Illuminator-Activation Determination Process

FIG. 10 is a flowchart illustrating a non-limiting example of activation of the illuminator. That is, FIG. 10 is a flowchart illustrating a specific example of S210.

The computer 22 issues an instruction that causes the entire-body driver 215 to adjust the position of each of the camera 211 and the illuminator 213 in the tire width direction (vehicle width direction) based on tire specifications (S211), and causes the camera 211 to acquire an image of the vehicle (S212) so that the vehicle's shape is detected from the image captured by the camera 211. The computer 22 compares, for example, the size (width, height) of the vehicle with acquired vehicle-shape information to detect the distance between the camera 211 and the vehicle 90 (tire FT) (distance used to determine illuminator activation) (S213).

The computer 22 repeats the acquisition of the vehicle's image (S212), and the detection of the distance used to determine illuminator activation (S213), as long as the distance used to determine illuminator activation is greater than an illuminator activation threshold (S214: NO).

When the distance used to determine illuminator activation becomes less than or equal to the illuminator activation threshold (S214: YES), the computer 22 adjusts, based on the vehicle's image, the angle of the illuminator 213 such that illumination (illumination light) is directed onto the tire (S215). The computer 22 then activates the illuminator 213 (S216). Once the illuminator 213 is activated, the computer 22 ends the illuminator activation process (S210), and proceeds to the initial-angle adjustment process for the imaging device (S300).

### Initial Angle Adjustment 1

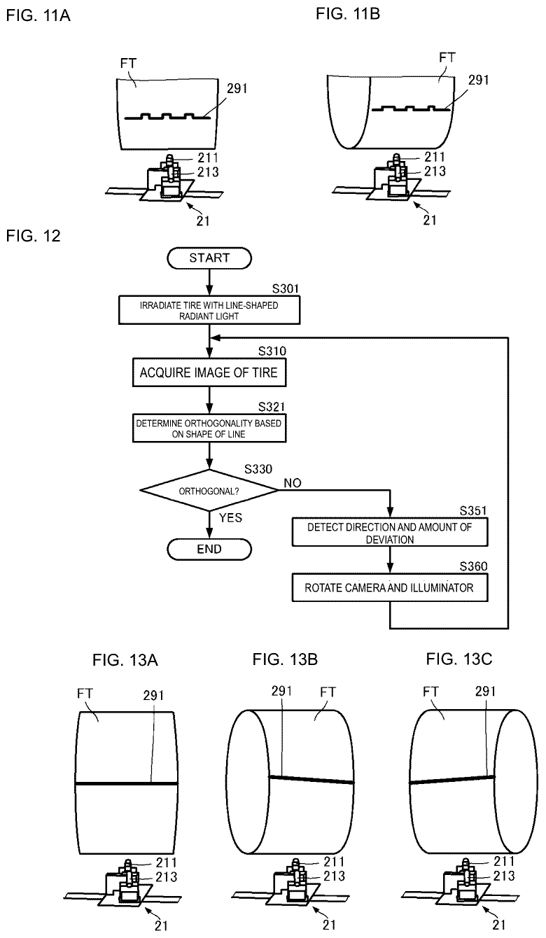

FIGS. 11A and 11B each schematically illustrate a first example of the angular relationship between the tire surface and the imaging device at the time of initial adjustment. FIG. 11A illustrates a case in which the optical axis of the imaging device (camera) and the tire surface are orthogonal or substantially orthogonal to each other in the horizontal direction. FIG. 11B illustrates a case in which the optical axis of the imaging device (camera) and the tire surface are not orthogonal to each other in the horizontal direction.

FIG. 12 is a flowchart of angle adjustment. FIG. 12 is a flowchart illustrating a first aspect of initial angle adjustment. The illuminator 213 radiates, toward a tire, line-shaped radiant light that extends in the width direction of the tire (S301). That is, the illuminator 213 radiates light toward the vehicle 90 as the vehicle 90 approaches the illuminator 213. As a result, a tire image is acquired in which, on the surface of the tire FT, the line-shaped radiant light radiated from the illuminator 213 forms an image 291 (see FIGS. 11A and 11B) extending in the width direction of the tire FT, and the shape of the line of light radiated on the tire is acquired (S310).

An orthogonality determination is performed based on the line's shape (the shape of the image 291 of line-shaped radiant light) (S321). More specifically, based on the line's shape (the shape of the image 291 of line-shaped radiant light), it is detected whether, as seen in plan view, the optical axis CCA of the camera 211 (the center of the camera 211) is aligned or substantially aligned in angle with the surface of the tire FT (i.e., the direction of travel of the vehicle).

If the surface of the tire FT, and the optical axis CCA of the camera 211 are orthogonal or substantially orthogonal to each other as illustrated in FIG. 11A, an image of the grooves of the tire FT, which is in the image 291 of line-shaped radiant light, is uniform. By contrast, if the surface of the tire FT, and the optical axis CCA of the camera 211 are not orthogonal to each other as illustrated in FIG. 11B, an image of the grooves of the tire FT, which is in the image 291 of line-shaped radiant light, is non-uniform. The degree of non-uniformity, or distribution, is determined uniquely by the angle (horizontal angle) of the optical axis CCA of the camera 211 relative to the surface of the tire FT in the horizontal direction.

Accordingly, the horizontal angle of the optical axis CCA of the camera 211 relative to the surface of the tire FT can be detected based on the line's shape.

If the computer 22 determines that the surface of the tire FT, and the optical axis CCA of the camera 211 are not orthogonal to each other (S330: NO), the computer 22 detects the direction and amount of angular deviation in the horizontal direction (S351). Based on the direction and amount of angular deviation, the computer 22 calculates an amount of angle adjustment (amount of rotation) to adjust the horizontal angle. The computer 22 outputs angle control information including the amount of angle adjustment to the imaging device 21. Based on the angle control information, the imaging device 21 controls the support 2152 and the mount securing structure 2153 to thereby adjust the horizontal angle of the camera 211 (S360).

The determination of orthogonality may be made based on whether strict orthogonality exists. Alternatively, with a measurement error or other factors taken into account, the determination of orthogonality may be made based on whether the horizontal angle is within a predetermined threshold range including an orthogonal angle (90 degrees).

The computer 22 and the imaging device 21 repeat the adjustment of the horizontal angle of the camera 211 until it is determined that the surface of the tire FT and the optical axis CCA of the camera 211 are orthogonal or substantially orthogonal to each other.

If the computer 22 determines that the surface of the tire FT and the optical axis CCA of the camera 211 are orthogonal or substantially orthogonal to each other (S330: YES), the computer 22 ends the initial angle adjustment.

The processing described above makes it possible to improve the reliability with which the tire observation apparatus 20 moves the camera 211 to the position directly in front of the tire FT to ensure that the optical axis of the camera 211 is orthogonal or substantially orthogonal to the surface of the tire FT in the horizontal direction. The tire observation apparatus 20 thus enables reduced error in the measurement of the tire surface condition.

Adjustment of the horizontal angle can be also performed, for example, by using a method described below.

### Initial Angle Adjustment 2

FIGS. 13A to 13C each schematically illustrate a second example of the angular relationship between the tire surface and the imaging device at the time of initial adjustment. FIG. 13A illustrates a case in which the optical axis of the imaging device (camera) and the tire surface are orthogonal or substantially orthogonal to each other in the horizontal direction. FIGS. 13B and 13C each illustrate a case in which the optical axis of the imaging device (camera) and the tire surface are not orthogonal to each other in the horizontal direction.

In the second example illustrated in FIGS. 13A to 13C, the computer 22 detects a horizontal angle by using an angle formed by line-shaped radiant light in the horizontal direction, in other words, an angle that the image 291 of line-shaped radiant light forms with the width direction connecting both side ends of the tire FT at the shortest distance.

When the surface of the tire FT and the optical axis CCA of the camera 211 are orthogonal or substantially orthogonal to each other in the horizontal direction as illustrated in FIG. 13A, the image 291 of line-shaped radiant light is horizontal in orientation. In other words, the image 291 of line-shaped radiant light is orthogonal or substantially orthogonal to both side surfaces of the tire FT. At this time, the width direction connecting both side ends of the tire FT at the shortest distance, and the direction in which the image 291 of line-shaped radiant light extends are parallel or substantially parallel to each other.

In contrast, when the surface of the tire FT and the optical axis CCA of the camera 211 are not orthogonal to each other in the horizontal direction as illustrated in FIGS. 13B and 13C, the image 291 of line-shaped radiant light is not horizontal in orientation but inclined relative to the horizontal direction. In other words, the image 291 of line-shaped radiant light is not orthogonal or substantially orthogonal to both side surfaces of the tire FT but intersects the side faces at a predetermined angle that is not 90 degrees. The inclination of the image 291 of line-shaped radiant light relative to the horizontal direction is determined uniquely by the angle (horizontal angle) of the optical axis CCA of the camera 211 relative to the surface of the tire FT in the horizontal direction. A flowchart (not illustrated) for Angle Adjustment 2 described above is based on the flowchart illustrated in FIG. 12, but differs from the flowchart illustrated in FIG. 12 in the following respects: S321 is changed to S322 “PERFORM ORTHOGONALITY DETERMINATION BASED ON WHETHER LINE IS ORTHOGONAL TO BOTH SIDE FACES OF TIRE”, and S351 is changed to “CALCULATE DIRECTION AND AMOUNT OF DEVIATION BASED ON ANGLE OF LINE TO BOTH SIDE FACES OF TIRE (S352).”

In actuality, due to tire tread, the image 291 of line-shaped radiant light is not a straight line as illustrated in each of FIGS. 13A to 13C but has irregularities as illustrated in each of FIGS. 11A and 11B. To address this, image processing is performed that involves extracting, from among the irregularities, only line-shaped radiant light corresponding to the tire surface, and checking the inclination of the line-shaped radiant light. In this way, the horizontal angle of the optical axis CCA of the camera 211 relative to the surface of the tire FT can be detected based on the above-described inclination of the image 291 of line-shaped radiant light.

### Initial Angle Adjustment 3

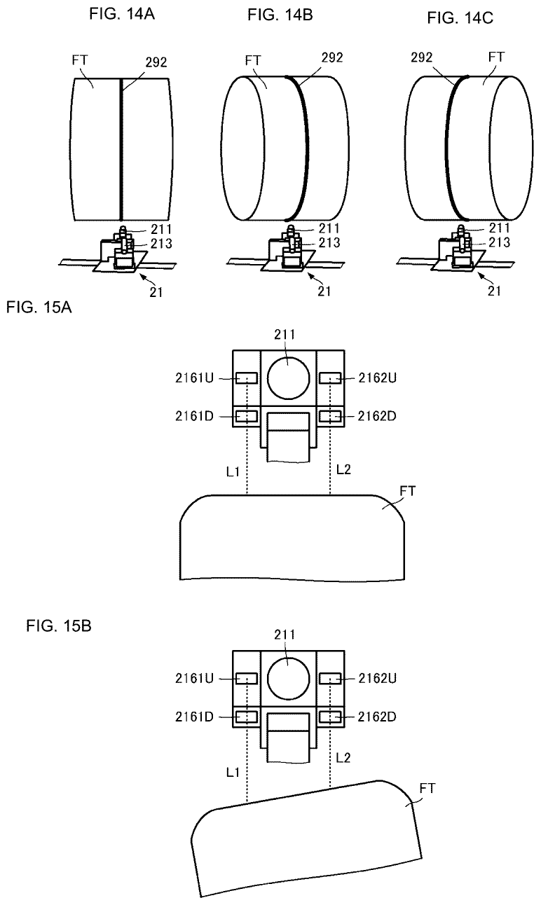

FIGS. 14A to 14C each schematically illustrate a third example of the angular relationship between the tire surface and the imaging device at the time of initial adjustment. FIG. 14A illustrates a case in which the optical axis of the imaging device (camera) and the tire surface are orthogonal or substantially orthogonal to each other in the horizontal direction. FIGS. 14B and 14C each illustrate a case in which the optical axis of the imaging device (camera) and the tire surface are not orthogonal to each other in the horizontal direction.

In the third example illustrated in FIGS. 14A to 14C, the computer 22 detects a horizontal angle by using the curvature and direction of curving of line-shaped radiant light in the vertical direction.

When the surface of the tire FT and the optical axis CCA of the camera 211 are orthogonal or substantially orthogonal to each other in the horizontal direction as illustrated in FIG. 14A, an image 292 of line-shaped radiant light is a straight line extending in the vertical direction.

In contrast, when the surface of the tire FT and the optical axis CCA of the camera 211 are not orthogonal to each other in the horizontal direction as illustrated in FIGS. 14B and 14C, the image 291 of line-shaped radiant light is not a straight line extending in the vertical direction but is a curve with a predetermined direction of curving and a predetermined curvature. The curvature and direction of curving of the image 292 of line-shaped radiant light are determined uniquely by the angle (horizontal angle) of the optical axis CCA of the camera 211 relative to the surface of the tire FT in the horizontal direction. A flowchart (not illustrated) for Angle Adjustment 3 described above is based on the flowchart illustrated in FIG. 12, but differs from the flowchart illustrated in FIG. 12 in the following respects: S321 is changed to “PERFORM ORTHOGONALITY DETERMINATION BASED ON WHETHER LINE IS VERTICALLY STRAIGHT LINE (S323)”, and S323 is changed to “CALCULATE DIRECTION AND AMOUNT OF DEVIATION BASED ON HOW LINE IS CURVED (S353).”

In this case, as previously described, the actual shape of the line has irregularities due to tire tread. To address this, whether the image 292 of line-shaped radiant light is curved is detected only from a measurement area corresponding to the tire surface. In this way, the horizontal angle of the optical axis CCA of the camera 211 relative to the surface of the tire FT can be detected based on the curvature and direction of curving of the image 292 of line-shaped radiant light.

### Initial Angle Adjustment 4

FIGS. 15A and 15B each schematically illustrate an example of the angular relationship between the tire surface and the imaging device at the time of initial adjustment. FIG. 15A illustrates a case in which the optical axis of the imaging device (camera) and the tire surface are orthogonal or substantially orthogonal to each other in the horizontal direction. FIG. 15B illustrates a case in which the optical axis of the imaging device (camera) and the tire surface are not orthogonal to each other in the horizontal direction.

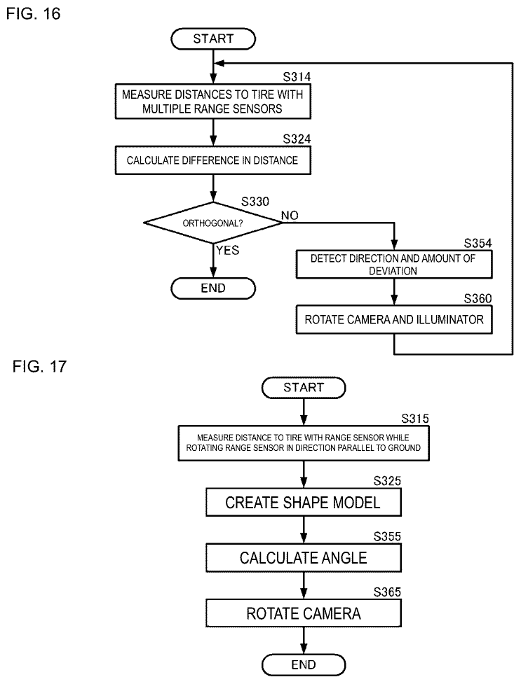

An angle adjustment method using the range sensors is illustrated in FIG. 16. FIG. 16 is a flowchart illustrating the angle adjustment method using the range sensors.

First, the distance between the range sensor 2161U and the tire, and the distance between the range sensor 2162U and the tire are calculated (S314). Then, the difference between the determined distances is calculated (S324).

When the surface of the tire FT and the optical axis CCA of the camera 211 are orthogonal or substantially orthogonal to each other in the horizontal direction as illustrated in FIG. 15A, a distance L1 and a distance L2 are equal or substantially equal. By contrast, when the surface of the tire FT and the optical axis CCA of the camera 211 are not orthogonal to each other in the horizontal direction as illustrated in FIG. 15B, the distance L1 and the distance L2 have a predetermined difference. The difference in distance is determined uniquely by the angle (horizontal angle) of the optical axis CCA of the camera 211 relative to the surface of the tire FT in the horizontal direction.

Accordingly, the horizontal angle of the optical axis CCA of the camera 211 relative to the surface of the tire FT can be detected based on the difference between the distances measured by the range sensors arranged alongside each other in the horizontal direction.

If the difference in distance is large, the computer 22 determines that the surface of the tire FT and the optical axis of the camera 211 are not orthogonal to each other (S330: NO). From the difference in distance, the computer 22 calculates the direction and amount of deviation (S354). The computer 22 then sets an amount of angle adjustment to adjust the horizontal angle (which corresponds to “second amount of adjustment”). The computer 22 outputs horizontal-angle control information including the amount of angle adjustment to the imaging device 21. The imaging device 21 adjusts the horizontal angle of the camera 211 by using the horizontal-angle control information (S360).

The determination of orthogonality may be made based on whether strict orthogonality exists. Alternatively, with a measurement error or other factors taken into account, the determination of orthogonality may be made based on whether the horizontal angle is within a predetermined threshold range including an orthogonal angle (90 degrees).

The computer 22 and the imaging device 21 repeat the adjustment of the horizontal angle of the camera 211 until it is determined that the surface of the tire FT and the optical axis CCA of the camera 211 are orthogonal or substantially orthogonal to each other. If the angle adjustment and the position adjustment are to be performed by use of the range sensors, the illuminator activation process at S210 may be omitted.

### Initial Angle Adjustment 5

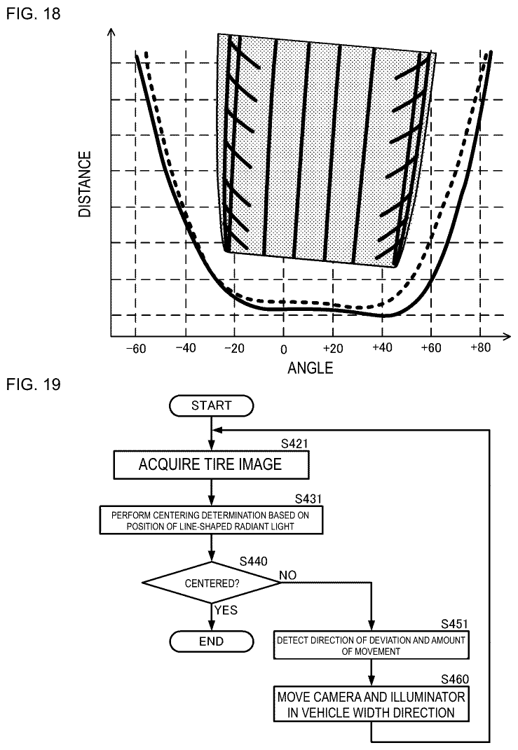

FIG. 17 is a flowchart illustrating a fifth example of an angle adjustment method using the range sensor. FIG. 18 illustrates an example of angle and distance measurements of the range sensor relative to the tire, and an example of a tire shape model based on the measurements.

The range sensor is rotated relative to the tire about an axis aligned with the vertical direction (S315). That is, the range sensor is rotated by the entire-body driver 215. As a result, the relationship between angle and distance as illustrated in FIG. 18 is determined.

Based on the relationship between angle and distance, a tire shape model is created (S325). Creating such a tire shape model makes it possible to calculate where the tire is located. Based on data of the shape model, an angle to make the optical axis of the camera orthogonal or substantially orthogonal to the tire surface is calculated (S355).

Then, based on the calculated angle, the computer 22 generates angle control information including an amount of angle adjustment, and outputs the angle control information to the imaging device 21. The imaging device 21 rotates the camera 211 by using the angle control information to thus adjust the horizontal angle of the camera 211 (S365). Once the initial angle adjustment is finished through the method described above, the computer 22 ends the initial angle adjustment process (S300), and proceeds to the initial position adjustment process (S400).

### Initial Position Adjustment 1

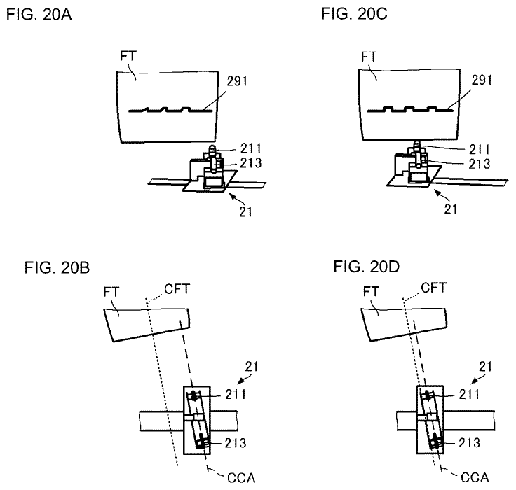

FIG. 19 is a flowchart of a first aspect of initial position adjustment of the imaging device, illustrating an example of initial position adjustment made by using an image of line-shaped radiant light radiated by the illuminator 213. FIGS. 20A to 20D each schematically illustrate an example of the positional relationship between the tire and the imaging device at the time of initial position adjustment. FIGS. 20A and 20B each illustrate a case in which the amount of misalignment in the horizontal direction between the optical axis CCA of the camera 211 and the center CFT of the tire FT is large. FIGS. 20C and 20D each illustrate a case in which the amount of misalignment in the horizontal direction between the optical axis CCA of the camera 211 and the center CFT of the tire FT is small. FIGS. 20A and 20C are illustrations with the tire FT viewed from the imaging device 21, and FIGS. 20B and 20D are illustrations in plan view.

The camera 211 captures an image of the tire FT including the image 291 of line-shaped radiant light on the surface of the tire FT (S421). In other words, the camera 211 receives the reflection of the line-shaped radiant light reflected by the surface of the tire FT. The captured image of the tire including the image 291 of line-shaped radiant light is input to the computer 22.

The computer 22 detects, from the captured image of the tire, where the line-shaped radiant light appears within the captured image of the tire, that is, where the line-shaped radiant light is located in the tire width direction, and performs centering determination (S431).

For example, when the amount of misalignment in the horizontal direction between the center CFT of the tire FT and the optical axis CCA of the camera 211 is large as illustrated in FIGS. 20A and 20B, the position of the image 291 of line-shaped radiant light within the captured image of the tire deviates from the center of the captured image of the tire.

In contrast, when the amount of misalignment in the horizontal direction between the center CFT of the tire FT and the optical axis CCA of the camera 211 is small as illustrated in FIGS. 20C and 20D, or when the amount of misalignment is zero, the image 291 of line-shaped radiant light is centered or substantially centered within the captured image of the tire.

If the computer 22 determines that the center CFT of the tire FT and the optical axis CCA of the camera 211 are not located at the same or substantially the same position, in other words, the camera 211 is not at the center in the width direction of the tire (S440: NO), the computer 22 detects, with respect to the tire width direction (vehicle width direction), the direction of deviation, and the amount of movement to perform position adjustment (S451). The computer 22 outputs the amount of movement to the imaging device 21. The imaging device 21 adjusts the horizontal position of the camera 211 by using the amount of movement (S460). Adjusting the horizontal position of the camera 211 means moving the camera 211 in the horizontal direction by the slider 2150 and the slider mating structure 2151 of the entire-body driver 215.

The determination of whether the center CFT of the tire FT and the optical axis CCA of the camera 211 are located at the same or substantially the same position may be made based on whether the amount of misalignment in the horizontal direction is zero. Alternatively, however, the computer 22 may, by taking a measurement error or other factors into account, make this determination based on whether the amount of misalignment in the horizontal direction is within a predetermined threshold range. The predetermined threshold range may be set in advance, or may be acquired from a database together with tire specifications set for individual vehicles.

The computer 22 and the imaging device 21 repeat the adjustment of the horizontal position of the camera 211 until it is determined that the center CFT of the tire FT and the optical axis CCA of the camera 211 are located at the same or substantially the same position.

If the position of the image of line-shaped radiant light deviates by a predetermined value or more from the center in the vertical direction, an adjustment may be made by the first position and angle adjustment device, in particular, the camera rotator 212, such that the image is located at or approximately at the center.

If the computer 22 determines that the center CFT of the tire FT and the optical axis CCA of the camera 211 are located at the same or substantially the same position (S440: YES), the camera 211 proceeds to a measurement-start-distance determination process (S500) without performing position adjustment of the camera 211.

### Initial Position Adjustment 2

A second initial position adjustment uses multiple range sensors 2161U and 2162U that sandwich the camera 211 in the horizontal direction (direction parallel to the road surface). This method can be used when the tire is within a measurable range of the range sensors.

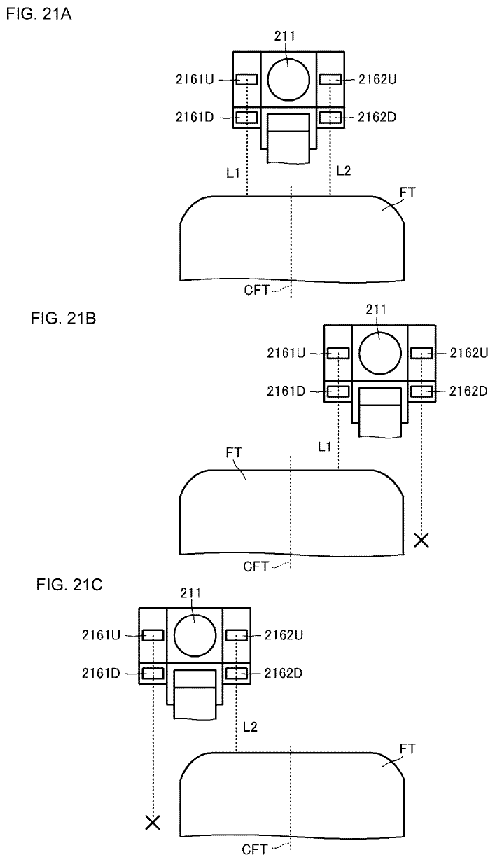

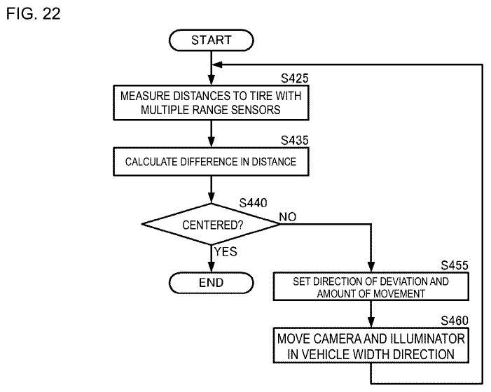

An example of a second initial-position adjustment method is described below with reference to FIGS. 21A to 21C and to the flowchart in FIG. 22. FIGS. 21A to 21C each schematically illustrate an example of the positional relationship between the tire and the imaging device at the time of initial position adjustment. FIG. 21A illustrates a case in which the amount of misalignment in the horizontal direction between the imaging device 21 and the tire FT is small. FIGS. 21B and 21C each illustrate a case in which the amount of misalignment in the horizontal direction between the imaging device 21 and the tire FT is large. FIG. 22 is a flowchart illustrating the second position adjustment method.

The range sensors 2161U and 2162U respectively measure the distance L1 to the tire FT and the distance L2 to the tire FT (S425). The distance L1 and the distance L2 respectively correspond to a “third distance” and a “fourth distance”.

The computer 22 calculates the difference between the following distances: the distance L1 between the range sensor 2161U and the tire FT, and the distance L2 between the range sensor 2162U and the tire FT (S435).

For example, when, as illustrated in FIG. 21A, the amount of misalignment in the horizontal direction between the center CFT of the tire FT and the camera 211 is small, and the tire FT exists in front of the range sensors 2161U and 2162U, the distance L1 and the distance L2 are equal or substantially equal. Therefore, the difference between the distance L1 and the distance L2 is substantially zero.

By contrast, when, as illustrated in FIG. 21B, the amount of misalignment in the horizontal direction between the center CFT of the tire FT and the camera 211 is large, and the tire FT exists in front of the range sensor 2161U but does not exist in front of the range sensor 2162U, it is possible to measure the distance L1 but impossible to measure the distance L2. That is, the distance L2 can be substituted with, for example, infinity. This results in a significantly increased difference between the distance L1 and the distance L2.

When, as illustrated in FIG. 21C, the amount of misalignment in the horizontal direction between the center CFT of the tire FT and the camera 211 is large, and the tire FT does not exist in front of the range sensor 2161U but exists in front of the range sensor 2162U, it is possible to measure the distance L2 but impossible to measure the distance L1. That is, the distance L1 can be substituted with, for example, infinity. This results in a significantly increased difference between the distance L1 and the distance L2.

Therefore, whether the misalignment between the center CFT of the tire FT and the camera 211 is large can be determined by using the difference in distance between the distance L1 and the distance L2.

If the computer 22 determines that the difference in distance is greater than a misalignment threshold, that is, if the computer 22 determines that the difference in distance is greater than or equal to a movement-control threshold, and that the imaging device 21 is at a position that deviates from the center in the width direction of the tire (S440: NO), the computer 22 sets an amount of movement to perform horizontal position adjustment (S455). The computer 22 generates movement control information including the amount of movement, and outputs the movement control information to the imaging device 21. The imaging device 21 adjusts the horizontal position of the camera 211 by using the amount of movement (S460). The misalignment threshold is set with a measurement error or other factors taken into account.

The computer 22 and the imaging device 21 repeat the adjustment of the horizontal position of the camera 211 until the difference in distance becomes less than or equal to the misalignment threshold. Adjusting the horizontal position of the camera 211 means moving the camera 211 in the horizontal direction.

In this way, the imaging device can be adjusted to a suitable position for imaging relative to the tire to be measured, that is, to a position aligned with the central portion of the tire.

Once the initial position adjustment is finished, the computer 22 proceeds to S500 in the flowchart of FIG. 9, at which the computer 22 determines whether the distance is less than or equal to the measurement-start threshold.

### Distance Determination 1

The computer 22 measures a line length (the length of the image 291 of line-shaped radiant light). The computer 22 calculates, from the line length, the distance between the camera 211 and the tire FT. The above-described distance can be calculated through, for example, simple geometric computation.

If the above-described distance is less than or equal to a measurement-start distance (measurement-start threshold), the computer 22 determines that it is now possible to measure the tire surface, and ends the initial adjustment process to proceed to tire surface measurement.

### Distance Determination 2

If range sensors are to be used, the distance between the camera 211 and the tire is determined by determining the coordinates of the center position of the tire by use of two range sensors, which are the range sensors 2161U and 2121L or the range sensors 2162U and 2162U. If the distance between the camera 211 and the tire is less than or equal to a measurement-start distance (measurement-start threshold), the computer 22 ends the initial adjustment process, and proceeds to tire surface measurement.

If the computer 22 determines that the distance between the camera 211 and the tire FT is greater than the measurement-start threshold (S500: NO), the computer 22 returns to the point just before S300 in FIG. 9, and performs the initial angle adjustment and the initial position adjustment again. The computer 22 repeats the processing described above until the distance between the camera 211 and the tire FT becomes less than or equal to the measurement-start threshold.

The processing described above makes it possible to improve the reliability with which the tire observation apparatus 20 moves the camera 211 to the position directly in front of the tire FT to ensure that the optical axis of the camera 211 be orthogonal or substantially orthogonal to the surface of the tire FT in the horizontal direction. As a result, the tire observation apparatus 20 allows the camera 211 or the illuminator 213 to be disposed at a position and an angle that are suitable for accurate measurement, relative to the tire FT of the vehicle 90 that is in motion. The tire observation apparatus 20 thus allows for reduced error in the measurement of the tire surface condition.

### Example of Measurement of Tire Surface Condition (S700)

### Pre-Imaging Fine Adjustment of Position and Angle of Imaging Device

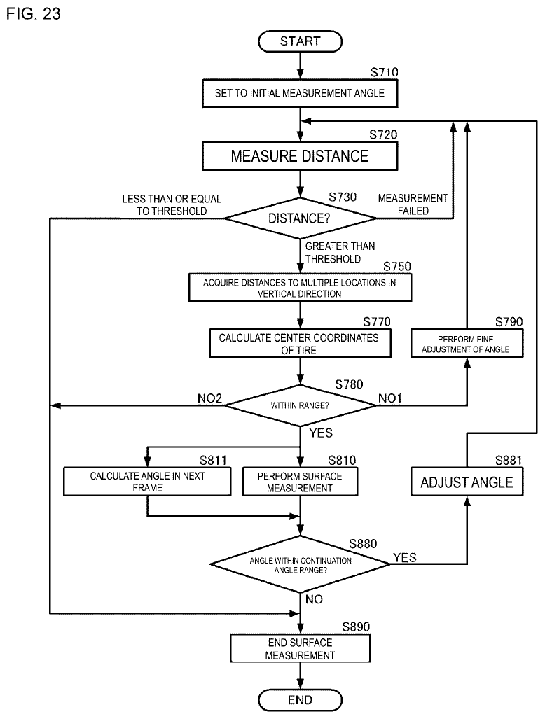

FIG. 23 is a flowchart illustrating an example of a measurement process for the surface condition of the tire.

The computer 22 sets an initial measurement angle of the camera 211 (S710). The angle in this case means the angle of the camera 211 or the illuminator 213 in the vertical direction, that is, an imaging angle that is set by use of the camera rotator 212 or the illuminator rotator 214.

FIG. 24 illustrates, in side view, an initial measurement angle of the camera. As illustrated in FIG. 24, an initial measurement angle of the camera 211 is set such that the ranging direction (the center axis of the ranging area) of the range sensors 2161D and 2162D, which are disposed vertically below, is parallel or substantially parallel to the horizontal direction or oriented upward relative to the horizontal direction. As a result, the calculation of the tire's center position can be performed by the computer 22 more reliably from the initial state. Depending on the height of the imaging device, the initial angle of range sensors such as the range sensors 2161D and 2162D is oriented downward relative to the horizontal direction.

At least one of the range sensor 2161U or the range sensor 2162U measures the distance to the tire FT (S720). If the distance to the tire FT is less than or equal to a measurement end threshold to end measurement of the tire surface condition (S730), the computer 22 ends surface condition measurement (S890). If the computer 22 fails to measure the distance to the tire FT (S730), the computer 22 continues distance measurement (S720).

If the distance to the tire FT is greater than the measurement end threshold to end measurement of the tire surface condition (S730), that is, if the imaging device 21 is not too close to the tire FT, the computer 22 proceeds to the next step in the measurement. The tire observation apparatus 20 is thus able to measure the tire surface condition under a suitable measurement condition. This results in improved measurement accuracy.

If the distance to the tire FT is greater than the measurement end threshold to end measurement of the tire surface condition (S730), the computer 22 acquires distances to multiple locations in the vertical direction on the surface of the tire FT (S750). More specifically, the computer 22 acquires distance measurements obtained with the range sensor 2161U and the range sensor 2161D that are arranged alongside each other in the vertical direction, or distance measurements obtained with the range sensor 2162U and the range sensor 2162D that are arranged alongside each other in the vertical direction. As a result of the initial angle being set as described above, a measurement of the distance to the surface of the tire FT can be acquired more reliably also from the range sensor 2161D or the range sensor 2162D, which is the lower-positioned sensor in the vertical direction.

The computer 22 calculates the center coordinates of the tire FT by using distance measurements obtained with the range sensors 2161U and 2161D arranged alongside each other in the vertical direction, or distance measurements obtained with the range sensors 2162U and 2162D arranged alongside each other in the vertical direction (S770). The following description is directed to a case in which the calculation is performed by using distance measurements obtained with the range sensors 2162U and 2162D arranged alongside each other in the vertical direction.

FIG. 25A illustrates, in side view, the principle of determination of the center coordinates of the tire. FIG. 25B illustrates, in side view, the vertical angle ΨC of the camera when the optical axis of the camera is directed at the center of the tire.

A radius R of the tire FT is obtained from the tire specifications. The angle ΨD provided by the respective ranging directions of the range sensors 2161U and 2161D is known and, for example, stored in the storage device 250.

A distance DU is measured by the range sensor 2162U. That is, the distance DU is the distance between the range sensor 2162U, and the intersection point of a ranging axis AX2162U of the range sensor 2162U and the surface of the tire FT. A distance DD is measured by the range sensor 2162D. That is, the distance DD is the distance between the range sensor 2162U, and the intersection point of a ranging axis AX2162D of the range sensor 2162D and the surface of the tire FT. The distances DU and DD are respectively measured by the range sensors 2162U and 2162D at step S64 described above.

With the intersection point of the ranging axis AX2162U and the ranging axis AX2162D defined as the origin (0, 0), once the distance DU, the distance DD, and the angle ΨD provided by the two ranging axes are known, the coordinates PU (xU, zU) of the intersection point of the ranging axis AX2162U and the surface of the tire FT, and the coordinates PD (xD, zD) of the intersection point of the ranging axis AX2162D and the surface of the tire FT can be calculated.

Since the respective coordinates PU (xU, zU) and PD (xD, zD) of the above-described two intersection points, which are two different points on the outer circumference of the tire FT, and the radius R of the tire FT are now known, the center coordinates Pc (xc, zc) of the tire FT can be calculated.

Example 1 of Measurement of Tire Surface Condition (Determination from Image)

After calculating the center coordinates Pc (xc, zc) of the tire FT, the computer 22 calculates the vertical angle ΨC of the camera 211.

Specifically, the following values are known: the distance L1 between the camera 211 and the rotation axis AXC; the distance L2 (height) of the rotation axis AXC from the horizontal surface (the ground surface); the coordinates p0c (x0c, z0c) of the rotation axis AXC; and the coordinates P0 (x0, z0) of the foot of a perpendicular or substantially perpendicular line drawn from the rotation axis AXC to the horizontal surface (ground surface). The angle ΨD is also known. Accordingly, based on the geometric position relationship between each of these known values and the center coordinates Pc (xc, zc), for example, the vertical angle ΨC of the camera 211 to direct the optical axis AX211 of the camera 211 at the center of the tire FT can be calculated.

If the center coordinates Pc (xc, zc) of the tire FT are within a measurement execution range to execute measurement (S780: YES), the computer 22 measures the surface condition of the tire FT (S810). The computer 22 calculates the vertical angle at the timing of the next measurement image (the next frame) (S811).

If the center coordinates Pc (xc, zc) of the tire FT is outside the measurement execution range, more specifically, if no real solution for the center coordinates Pc (xc, zc) is obtained (S780: NO1), the computer 22 performs fine adjustment of the vertical angle (S790). Fine adjustment of the vertical angle refers to changing the vertical angle only by a predetermined small angle.

If the center coordinates Pc (xc, zc) of the tire FT are outside the measurement execution range, more specifically, if the distance from the camera 211 to the center coordinates of the tire FT is less than or equal to a threshold to end measurement of the tire surface condition (S780: NO2), the computer 22 ends surface measurement (S890).

If the vertical angle in the next frame is within a continuation angle range (S880: Yes), the computer 22 generates angle control information, and provides the angle control information to the imaging device 21. The continuation angle range refers to a preset angle range within which the surface condition of the tire FT can be measured with accuracy by use of an image captured by the imaging device 21. The angle control information is set based on the difference between the vertical angle in the current frame and the vertical angle in the next frame. The imaging device 21 adjusts the vertical angle ΨC of the camera 211 by using the angle control information (S881).

The processing described above allows the tire observation apparatus 20 to accurately measure the surface condition of the tire FT.

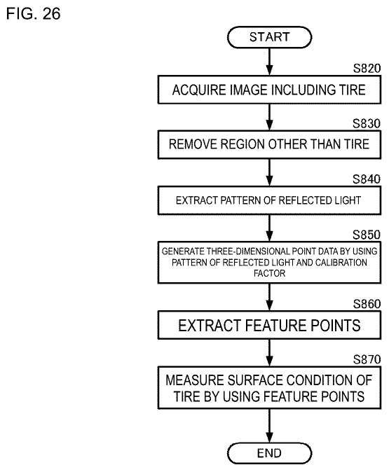

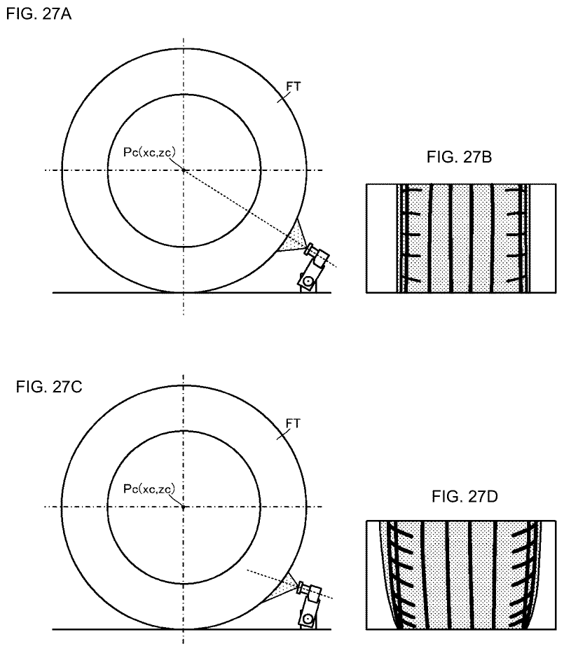

FIG. 26 is a flowchart illustrating an example of a measurement process using image processing to measure the surface condition of the tire. FIGS. 27A and 27C each illustrate an example of the positional relationship between the tire and the camera when image processing is performed, and FIGS. 27B and 27D each illustrate an example of the resulting image. FIG. 27A is an illustration, in side view, of the positional relationship between the observation apparatus and the tire with angle adjustment performed in accordance with the flowchart illustrated in FIG. 23. FIG. 27B is a conceptual illustration of the tire imaged as illustrated in FIG. 27A. In contrast, FIG. 27C is an illustration, in side view, of a case in which the angle adjustment illustrated in the flowchart of FIG. 23 has not been performed. FIG. 27D illustrates the tire imaged as illustrated in FIG. 27C.

The camera 211 acquires an image including the tire FT with its position and angle adjusted through the processing described above as illustrated in FIG. 27A (S820). The camera 211 outputs the image to the computer 22.

The computer 22 removes a region of the image other than the tire FT (S830). The computer 22 extracts a pattern of reflected light (S840). The computer 22 generates three-dimensional point data corresponding to individual pixels of the image by use of the pattern of reflected light and a configuration factor (S850).

The computer 22 extracts, from the three-dimensional point data, feature points representative of, for example, grooves or wear (S860). Such feature points can be extracted based on, for example, brightness differences. The computer 22 measures the surface condition (e.g., groove depth or uneven wear) of the tire FT by using the feature points (S870).

As illustrated in FIG. 27A, the configurations according to example embodiments of the present invention enable the camera 211 to be set at a position and an angle that are suitable to perform measurement directly in front of the tire FT (a position and an angle that allow accurate measurement), even when the vehicle 90 is in motion. As illustrated in FIG. 27B, the resulting image of the surface of the tire FT has a uniform outline shape. As a result, grooves or wear can be easily detected, which allows for easy improvement of measurement accuracy. Therefore, the tire observation apparatus 20 enables accurate measurement of the surface condition of the tire FT.

In contrast, if the configurations according to example embodiments of the present invention are not provided, it is not possible, as illustrated in FIG. 27C, to set the camera and the illuminator at their proper positions and angles. If large variations in tire width are thus present in the resulting image as illustrated in FIG. 27D, the image is to be corrected first to make the tire width substantially uniform. Such image correction inevitably leads to degradation of accuracy.

### Example 2 of Measurement of Tire Surface Condition (Use of Light-Section Method)

Reference is now made to control of the positional relationship between the tire, and each of the camera and the illuminator when the tire groove depth is measured through a light-section method.

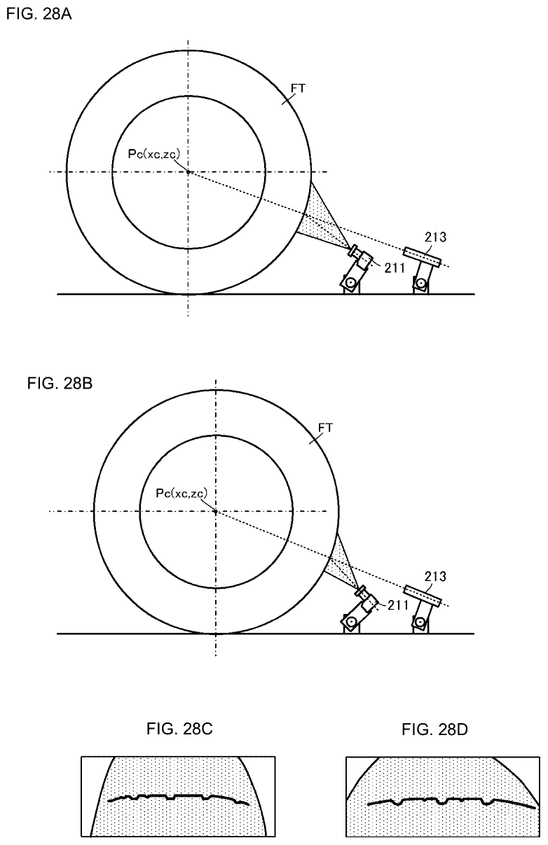

FIGS. 28A and 28B illustrate an imaging process performed with different distances between the tire and the measurement apparatus, the imaging process including radiating, with the illuminator 213, line-shaped radiant light toward the center of the tire, and imaging, at the center of the camera, the line-shaped radiant light radiated onto the tire. FIGS. 28C and 28D each illustrate an example of the resulting image. FIG. 28C illustrates an image corresponding to FIG. 28A, and FIG. 28D illustrates an image corresponding to FIG. 28B.

If the light-section method is to be used, the illuminator 213 radiates line-shaped radiant light extending in the horizontal direction (the width direction of the tire FT). Then, as illustrated in FIGS. 28A and 28B, the vertical angle ΨL of the illuminator 213 is adjusted such that the optical axis of the illuminator 213 passes through the center coordinates Pc (xc, zc) of the tire FT determined by the range sensor. The amount of adjustment of the angle at this time corresponds to a “third amount of adjustment”. Since the respective distances (not illustrated) of the camera and the illuminator are known, the adjustment is achieved by calculating the amount of adjustment such that the illumination axis of the illuminator passes through the center coordinates of the tire, in a manner the same as or similar to the above-described technique of adjusting the vertical angle ΨC of the camera 211 such that the optical axis of the camera 211 passes through the center coordinates Pc (xc, zc) of the tire FT.

Providing the configurations according to example embodiments of the present invention make it possible to clearly capture an image of line-shaped radiant light used for the light-section method as illustrated in FIGS. 28C and 28D, even when the distance between the camera 211 and the tire FT changes as the vehicle 90 moves. Since the angle of the optical axis of the camera to the tire surface is also known, the depth of tire grooves can be detected with accuracy.

In each of the tire surface measurement using an image, and the tire surface measurement using the light-section method, the processes to be executed by the computer 22 after data acquisition may be performed simultaneously with the measurement, or may be performed after the measurement is finished. That is, the processes corresponding to S820 to S870 performed during the measurement using an image (no flowchart is illustrated for the light-section method) may be performed in parallel or substantially in parallel while measurement of the image is performed, or may be performed collectively after the measurement is finished.

As a result, the tire observation apparatus 20 enables accurate measurement of the surface condition of the tire FT.

According to the configuration described above, the ranging direction (the center axis of the ranging area) of each of the range sensors 2161U and 2162U is set such that the ranging direction is parallel or substantially parallel to the optical axis of the camera 211, and the positions of these components in the direction of rotation of the rotation axis AXC are the same or substantially the same. That is, the angle that each of the range sensors 2161U and 2162U forms with the ground surface, and the angle that the imaging direction of the camera 211 forms with the ground surface are the same or substantially the same.

Alternatively, however, the angle that each of the range sensors 2161U and 2162U forms with the road surface, and the angle that the imaging direction of the camera 211 forms with the ground surface may be different. It is to be noted, however, that if these angles are the same or substantially the same, the vertical angle ΨC of the camera 211 can be calculated easily. As a result, in performing surface condition measurement for the vehicle 90 in motion, which particularly requires real-time processing, the vertical angle ΨC of the camera 211 can be adjusted at high speed as the vehicle 90 moves. This enables measurement accuracy to be improved with even greater reliability.

In another configuration, the flowchart of FIG. 23 is modified as described below. After the initial measurement angle is set (S710), distances are measured by a combination of the range sensors 2161U and 2162D or a combination of the range sensors 2162U and 2162D (S750). Of the measured distances, the distance measured by the range sensor 2161U or 2162U is used to determine whether the distance is suitable for measurement (S730), and if the distance is greater than a measurement threshold, the center coordinates of the tire are calculated (S770). If the tire's center coordinates thus calculated are within a range (S780: Yes), surface measurement is performed (S810). In this way as well, measurement can be performed with improved accuracy.

In the foregoing description, position adjustment or angle adjustment is performed for a vehicle that is in motion. In this regard, position adjustment or angle adjustment can be similarly performed for a vehicle that is at rest. When a vehicle is at rest, the vehicle and the camera do not change in position. Accordingly, rather than detecting the distance and then proceeding to the next process, the tire observation apparatus is able to, after setting the imaging device to a suitable position by performing position adjustment or angle adjustment, perform measurement of the tire surface on the spot. That is, if the tire observation apparatus is to measure the tire surface of a vehicle that is at rest, the tire observation apparatus is able to optimize the position or angle of the camera for accurate measurement of the tire surface, by controlling the position of the imaging device such that the tire is captured at the imaging center of the camera, or controlling the angle of the imaging device such that the imaging direction of the camera is orthogonal or substantially orthogonal to the tire surface.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A tire observation apparatus comprising:
a camera to acquire an image of a tire of a vehicle;
a plurality of range sensors each operable in conjunction with the camera to measure a distance to the tire;
a first position and angle controller configured or programmed to adjust at least one of a position or an angle, the position being a position of the camera and of each of the plurality of range sensors, the angle being an angle of the camera and of each of the plurality of range sensors; and a computer configured or programmed to measure a surface condition of the tire by using the image of the tire acquired by the camera; wherein
the plurality of range sensors are positioned at different angles relative to a ground;
the computer is configured or programmed to calculate a position of the tire relative to the camera by using a plurality of distances to the tire measured by the plurality of range sensors;
the computer is configured or programmed to calculate a first amount of adjustment by using the position of the tire, the first amount of adjustment being an amount of adjustment to adjust a position and an angle of the camera such that an imaging center of the camera is directed at a target position on the tire, the target position being a position to be measured; and
the first position and angle controller is configured or programmed to adjust the position and the angle of the camera by using the first amount of adjustment.

2. The tire observation apparatus according to claim 1, wherein
the plurality of range sensors include a first range sensor; and
a ranging direction of the first range sensor, and the imaging center of the camera are directed in a same or substantially a same direction.

3. The tire observation apparatus according to claim 2, wherein
the plurality of range sensors include a second range sensor; and
the second range sensor is positioned closer to the ground than is the first range sensor.

4. The tire observation apparatus according to claim 1, wherein
the plurality of range sensors include a first range sensor and a second range sensor; and
the first range sensor and the second range sensor are positioned such that a ranging direction of the first range sensor and a ranging direction of the second range sensor each define a predetermined angle in a vertical direction with an optical axis of the camera.

5. The tire observation apparatus according to claim 4, wherein the ranging direction of the first range sensor, and the ranging direction of the second range sensor define an angle greater than or equal to about 10 degrees and less than or equal to about 70 degrees.

6. The tire observation apparatus according to claim 1, further comprising:
an illuminator to radiate line-shaped radiant light; and
a second position and angle controller configured or programmed to adjust a position of the illuminator and an angle of the illuminator; wherein
the computer is configured or programmed to calculate a second amount of adjustment by using the position of the tire, the second amount of adjustment being an amount of adjustment to adjust at least one of the position or the angle of the illuminator to enable the illuminator to radiate the line-shaped radiant light onto the target position; and
the second position and angle controller is configured or programmed to adjust at least one of the position or the angle of the illuminator by using the second amount of adjustment.

7. The tire observation apparatus according to claim 6, wherein
the computer is configured or programmed to calculate a third amount of adjustment to adjust at least one of the position or the angle of the camera such that the line-shaped radiant light radiated onto the target position is located at a center of an imaging range; and
the first position and angle controller is configured or programmed to adjust at least one of the position or the angle of the camera by using the third amount of adjustment.

8. A tire observation apparatus comprising:
a camera to acquire an image of a tire of a vehicle;
an illuminator to radiate line-shaped radiant light;
a third position controller configured or programmed to move the camera and the illuminator in a direction parallel or substantially parallel to a ground and parallel or substantially parallel to a width direction of the tire; and
a computer configured or programmed to calculate an amount of movement of the camera and the illuminator; wherein
the illuminator radiates, onto the tire, the line-shaped radiant light that extends in the width direction of the tire;
the computer is configured or programmed to:
extract a line-shaped radiant-light image from the image acquired by the camera, the line-shaped radiant-light image being an image of the line-shaped radiant light radiated onto the tire; and
calculate, based on a shape of the line-shaped radiant-light image, the amount of movement to move the camera and the illuminator; and
the third position controller is configured or programmed to move the camera and the illuminator in the width direction of the tire by using the amount of movement.

9. The tire observation apparatus according to claim 8, wherein
the camera is operable to continuously capture an image including the line-shaped radiant-light image;
the computer is configured or programmed to:
continuously calculate a length of the line-shaped radiant-light image; and
in response to the length of the line-shaped radiant-light image being greater than or equal to a measurement-start threshold, stop calculation of the amount of movement for the third position controller; and
the third position controller is configured or programmed to stop movement of the camera and the illuminator in a width direction of the vehicle.

10. A tire observation apparatus comprising:
a camera to acquire an image of a tire of a vehicle;
a plurality of range sensors each provided at a fixed position relative to the camera, and that are each operable to measure a distance to the tire;
a third position controller configured or programmed to move the camera and the plurality of range sensors in a direction parallel or substantially parallel to a ground and in a width direction of the vehicle; and
a computer configured or programmed to calculate an amount of movement to move the camera and the plurality of range sensors; wherein
the plurality of range sensors include a third range sensor and a fourth range sensor sandwiching the camera in the direction parallel or substantially parallel to the ground;
the computer is configured or programmed to:
calculate a distance difference being a difference between a third distance and a fourth distance, the third distance being a distance to the tire measured by the third range sensor, the fourth distance being a distance to the tire measured by the fourth range sensor; and
when the distance difference is greater than or equal to a movement control threshold, calculate an amount of movement to move the camera and the plurality of range sensors in a direction in which a range sensor corresponding to a smaller one of the third and fourth distances exists; and
the third position controller is configured or programmed to move the camera and the plurality of range sensors by using the amount of movement.

11. The tire observation apparatus according to claim 10, wherein
the plurality of range sensors are operable to continuously measure a plurality of distances;
the computer is configured or programmed to:
calculate the distance difference based on the plurality of distances; and
in response to the distance difference being less than or equal to a measurement-start threshold, stop calculation of the amount of movement for the third position controller; and
the third position controller is configured or programmed to stop movement of the camera and the plurality of range sensors.

12. The tire observation apparatus according to claim 10, further comprising:
a third angle controller configured or programmed to rotate the camera and the plurality of range sensors about a rotation axis in a plane parallel or substantially parallel to the ground, the rotation axis being perpendicular or substantially perpendicular to the ground; wherein
when the distance difference is less than a measurement-start threshold and greater than or equal to a horizontal-angle control threshold, the computer is configured or programmed to calculate an amount of rotation to effect rotation in a direction in which a range sensor corresponding to a smaller one of the third and fourth distances exists; and
the third angle controller is configured or programmed to rotate, by using the amount of rotation, the camera and the plurality of range sensors in the plane parallel or substantially parallel to the ground.

13. A tire observation apparatus comprising:
a camera to acquire an image of a tire of a vehicle;
an illuminator to radiate line-shaped radiant light;
a third angle controller configured or programmed to rotate the camera and the illuminator in a plane parallel or substantially parallel to a ground;
a computer configured or programmed to calculate an amount of rotation to rotate the camera and the illuminator; wherein
the illuminator is operable to radiate, onto the tire, the line-shaped radiant light that extends in a width direction of the tire;
the camera is operable to capture an image of a tire irradiated with the line-shaped radiant light;
the computer is configured or programmed to calculate, based on a shape of a line-shaped radiant-light image, the amount of rotation to rotate the camera and the illuminator, the line-shaped radiant-light image being an image of the line-shaped radiant light within the captured image of the tire; and
the third angle controller is configured or programmed to rotate the camera and the illuminator by using the amount of rotation.

14. The tire observation apparatus according to claim 13, wherein
the illuminator is operable to radiate the line-shaped radiant light that extends in a horizontal direction parallel or substantially parallel to the ground; and
the computer is configured or programmed to:
calculate the amount of rotation based on an angle between the line-shaped radiant-light image and a width direction connecting both side ends of the tire with a shortest distance; and
when the line-shaped radiant-light image is parallel or substantially parallel to the width direction connecting both side ends of the tire, not calculate the amount of rotation.

15. A tire observation apparatus comprising:
a camera to acquire an image of a tire of a vehicle;
an illuminator to radiate line-shaped radiant light;
a third angle controller configured or programmed to rotate the camera and the illuminator in a plane parallel or substantially parallel to a ground; and
a computer configured or programmed to calculate an amount of rotation to rotate the camera and the illuminator; wherein
the illuminator is operable to radiate the line-shaped radiant light that extends in a circumferential direction of the tire;
the camera is operable to capture an image of the tire irradiated with the line-shaped radiant light; and
the computer is configured or programmed to:
calculate the amount of rotation based on a curvature and a direction of curving of a line-shaped radiant-light image being an image of the line-shaped radiant light within the captured image of the tire; and
when the line-shaped radiant-light image is a straight line, not calculate the amount of rotation.
